(19) United States
(12) Patent Application Publication
(10) Pub. No.: US 2009/0117398 A1
(43) Pub. Date: May 7, 2009

(54) Partly chrome-plateable device and method of manufacturing the same

(75) Inventors: Matthias Helmstetter, Aschaffenburg (DE); Werner Radde, Babenhausen (DE); Kurt Gebert, (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 12/290,831

(22) Filed: Nov. 3, 2008

(30) Foreign Application Priority Data
Nov. 6, 2007 (DE) 10 2007 052 849.5

(51) Int. Cl. B32B 15/08; B32B 27/08; C25D 5/56

(52) U.S. Cl. 428/461; 428/515; 205/164

(57) ABSTRACT

A device, in particular a vehicle interior component, includes a base body (10) made of a first plastic material which is suitable for injection molding and for coating with chromium. The device furthermore includes at least one elastic partial body (16, 18) molded to the base body (10), which is made of a second plastic material which is suitable for injection molding, but not for coating with chromium. A method for manufacturing such a device with a base body (10) coated with chromium comprises the following steps:
injection molding a base body (10) of the first plastic material;
injection molding the partial body (16, 18) of the second plastic material to the base body (10);
electroplating a chromium coating onto the base body (10), wherein the base body (10) passes through a chrome-plating bath together with the integrally molded partial body (16, 18).

### TECHNICAL FIELD

The invention relates to a device, in particular a vehicle interior component, comprising a base body of a first plastic material which is suitable for injection molding and for coating with chromium.

### BACKGROUND OF THE INVENTION

Traditionally, chrome-plated vehicle components are used in the automotive industry, for instance when a high-class equipment should be delimited against a standard equipment. As compared to other materials such as metal, base bodies made of a plastic material suitable for injection molding offer the advantages of design freedom, corrosion resistance and low weight. However, only certain plastic materials can be used for electroplating with chromium, such as acrylonitrile-butadiene-styrene copolymers (ABS) or polycarbonates with ABS (PC/ABS). Materials on this basis are suited to satisfy the high functional requirements of the automotive industry. On most of the other plastic materials, chromium or other metal layers can not or not permanently be applied.

The effect of chromium is of course also appreciated in other fields. As compared to uncoated articles, chrome-plated surfaces with a flawless, high-gloss appearance generally produce a particular impression of lasting value and luxury.

Upon installation of certain parts such as trims or covers, gaps are left between the same and adjoining parts independent of a coating with chromium. Due to different tolerances, the gaps generally cannot be kept as small as desired and have the same width everywhere. A suitable measure for concealing these tolerances is filling or covering the gaps, preferably such that a largely plane surface is obtained in general. Preferably, the fillings or covers can be manufactured at low cost, most preferably together with the base body of the part to be fitted, and should not get in conflict with a chromium coating of the base body.

It is an object of the invention to provide a solution which satisfies the above-mentioned requirements and creates a device with a base body which can optionally be coated with chromium, wherein the device in any case ensures the concealing of gaps.

### BRIEF SUMMARY OF THE INVENTION

In accordance with the invention, a device, in particular a vehicle interior component, comprises a base body made of a first plastic material which is suitable for injection molding and for coating with chromium. The device further comprises at least one elastic partial body molded to the base body, which is made of a second plastic material suitable for injection molding, but not for coating with chromium. The invention has the advantage that the partial body can easily be injection-molded to the base body independent of future chrome-plating. When a noble finish is desired, the entire device can pass through a chrome-plating bath. Due to the inventive combination of plastic materials, only the primarily visible base body will then be electroplated. This procedure is easier and less expensive to perform than mounting the partial body after chrome-plating the base body.

As a first plastic material for the base body, an acrylonitrile-butadiene-styrene copolymer (ABS) or a polycarbonate with an acrylonitrile-butadiene-styrene copolymer (PC/ABS) can optimally be used.

In accordance with one of many possible embodiments, the base body of the device of the invention comprises a trim for a vehicle steering wheel. The gap between the trim and the adjoining regions of the steering wheel can be concealed by the elastic partial body molded to the trim.

In accordance with another application of the invention, the base body comprises an air bag cover. When the air bag cover is part of a so-called floating horn module or in some other way performs a horn function by depressing, the elastic partial body can conceal the gap surrounding the cover without the horn function being impaired thereby.

The configuration of the partial body as a seal which keeps away dust, dirt and moisture is particularly advantageous.

However, the partial body also can constitute a membrane (clamped all around). Under the membrane, a switch can be mounted, which is protected by the membrane, but can be operated from outside due to the elasticity of the membrane.

In accordance with a further development of the invention, the partial body is translucent. In this case, the device in accordance with the invention preferably includes a light source, which illuminates the partial body. In this way, the device as such or a certain part of the device delimited by the partial body can be made better visible. The illumination also can be expedient for esthetic reasons.

The invention also provides a method for manufacturing a device with a base body coated with chromium, the method comprising the following steps:
injection molding the base body of the first plastic material;
injection molding the partial body of the second plastic material to the base body;
electroplating a chromium coating onto the base body, wherein the base body passes through a chrome-plating bath together with the integrally molded partial body.

### BRIEF DESCRIPTION OF THE DRAWINGS

FIG. 1 shows a partial view of a vehicle steering wheel with a device in accordance with the invention;

FIG. 2 shows a sectional view of the device in accordance with the invention as shown in FIG. 1; and

FIG. 3 shows a sectional view of a variant of the device in accordance with the invention as shown in FIGS. 1 and 2.

### DETAILED DESCRIPTION OF THE PREFERRED EMBODIMENTS

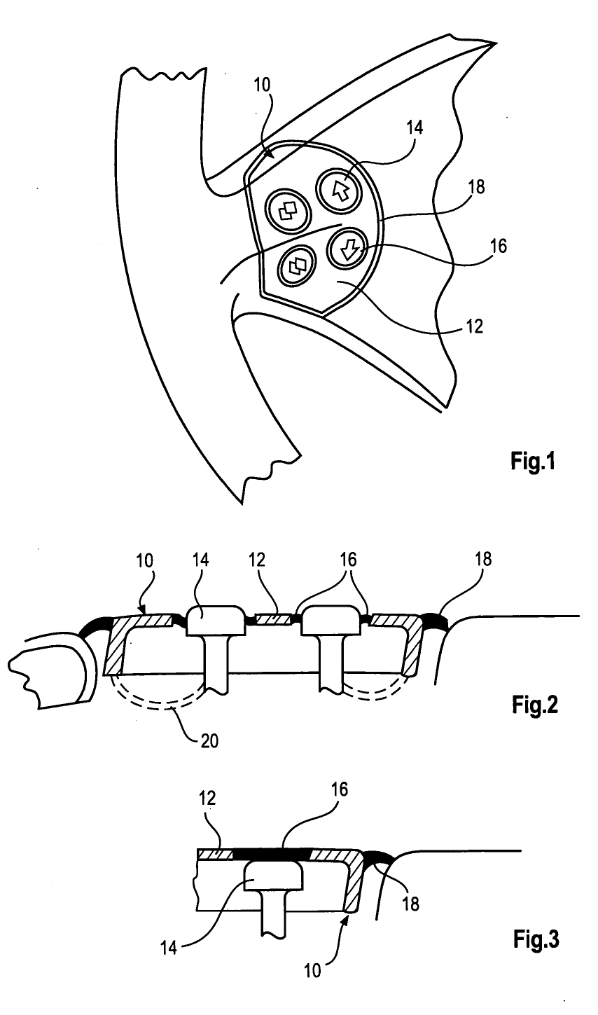

In FIG. 1a vehicle steering wheel is shown by way of example, in which a device in accordance with the invention is integrated. The device comprises a base body 10 in the form of a chrome-plated trim 12 with push buttons 14 for controlling certain vehicle functions. The base body 10 is made of a first plastic material suitable for injection molding, which is suitable for coating with chromium. Such material is e.g. ABS or PC/ABS.

The gaps between the buttons 14 and the trim 12 and between the trim 12 and the adjoining regions of the steering wheel are covered by elastic partial bodies 16 or 18, which thus conceal the gaps. The partial bodies 16, 18 are formed of a second plastic material suitable for injection molding, which in contrast to the material of the base body 10 is not suitable for coating with chromium. Such materials are e.g. polypropylene (PP), polyamide (PA), polycarbonate (PC).

Between the buttons 14 and the trim 12, the partial bodies 16 constitute ring-shaped membranes, which are attached on both sides (i.e. both to the trim 12 and to the respective button 14), but due to their elasticity ensure the necessary movability of the buttons 14. Along the outer edge of the trim 12, the elastic partial body 18 constitutes an elastic sealing lip unilaterally attached to the trim 12, which provides a largely flat transition to the adjacent foamed or leather-coated regions of the steering wheel. Apart from covering the gaps, the membranes and the sealing lip also serve as seals which advantageously prevent the ingress of dust, dirt and moisture into the gaps.

The exact structure of the trim 12 with the buttons 14 and the elastic partial bodies 16, 18 is shown in FIG. 2. When manufacturing the trim 12, which will be described in detail below, the buttons 14 initially are connected with the remaining base body 10 via break-off webs 20, as the membranes which connect the buttons 14 with the adjoining regions of the trim 12 will be injection molded only after injection molding the base body 10. The chromium layer applied onto the base body 10 including the buttons 14 is not shown separately.

The elastic partial bodies 16, 18 can be opaque or translucent. In the latter case, the partial bodies 16, 18 can be illuminated with one or more light sources disposed behind the trim, in order to make the buttons 14 visible in the dark. The illumination of the membranes and/or the sealing lip can also be effected for design reasons.

In the following, the manufacture of the device shown in FIGS. 1 and 2 will be described. In a first injection molding step, the trim 12 is injection molded from the first plastic material together with the buttons 14. The webs 20 (illustrated in FIG. 2 in broken lines), which connect the buttons 14 with the remaining base body of the trim, are also injection molded. In a second injection molding step, the elastic partial bodies 16, 18 are injection molded from the second plastic material, i.e. the spaces around the buttons 14 are filled and the sealing lip is injection molded to the outer edge of the base body 10.

Subsequently, the entire device passes through a chrome-plating bath for electroplating the surface in a manner known per se. As only the first plastic material is suitable for coating with chromium, a chromium layer will adhere only to the base body 10 including the buttons 14, but not to the elastic partial bodies 16, 18. The webs 20 no longer required are broken off upon passing through the chrome-plating bath. If no chromium layer is desired on the buttons 14, the webs 20 are broken off already before chrome-plating, so that the buttons 14 can be removed before passing through the chrome-plating bath.

In the concrete case, a chrome-plated trim 12 with chrome-plated buttons 14 thus is obtained. The membranes and the sealing lip (partial bodies 16 or 18) are not chrome-plated, so that their elasticity (and possibly translucency) is not impaired.

FIG. 3 shows a variant of the device in accordance with the invention as shown in FIGS. 1 and 2. Here, the push buttons 14 are disposed directly under the partial bodies 16 of the second plastic material, which form circular membranes. The membranes are so elastic that the buttons 14 can be depressed without the attachment of the membranes to the base body 10 being impaired. The membranes in turn can be translucent and be illuminated. Apart from the slightly different shape of the injection molding tools, the manufacture of this embodiment is effected by the method described above.

The invention is of course not restricted to the embodiments described above, but can likewise be employed with other devices from other technical fields.

1. A device, in particular a vehicle interior component, the device comprising a base body made of a first plastic material, which is suitable for injection molding and for coating with chromium, the device further comprising at least one elastic partial body molded to the base body, which is made of a second plastic material which is suitable for injection molding, but not for coating with chromium.

2. The device according to claim 1, wherein the first plastic material is an acrylonitrile-butadiene-styrene copolymer (ABS) or a polycarbonate with an acrylonitrile-butadiene-styrene copolymer (PC/ABS).

3. The device according to claim 1, wherein the base body comprises a trim for a vehicle steering wheel.

4. The device according to claim 1, wherein the base body comprises an air bag cover.

5. The device according to claim 1, wherein the partial body forms a seal.

6. The device according to claim 1, wherein the partial body forms a membrane.

7. The device according to claim 1, wherein the partial body is translucent.

8. The device according to claim 7, further comprising a light source which illuminates the partial body.

9. The device according to claim 1, wherein the base body is coated with chromium.

10. A method for manufacturing a device comprising a base body made of a first plastic material, which is suitable for injection molding and for coating with chromium, the device further comprising at least one elastic partial body molded to the base body, which is made of a second plastic material which is suitable for injection molding, but not for coating with chromium, the method comprising the following steps:
injection molding the base body of the first plastic material;
injection molding the partial body of the second plastic material to the base body;
electroplating a chromium coating onto the base body, wherein the base body passes through a chrome-plating bath together with the integrally formed partial body.
